(19) United States
(12) Patent Application Publication
(10) Pub. No.: US 2014/0233766 A1
(43) Pub. Date: Aug. 21, 2014

(54) FLAT-TYPE SPEAKER HAVING A PLURALITY OF CONSECUTIVELY CONNECTED MAGNETIC CIRCUITS

(71) Applicant: EXELWAY INC., Seoul-si (KR)

(72) Inventor: Dong-Man Kim, Dongdaemun-gu (KR)

(73) Assignee: EXELWAY INC., Seoul-si (KR)

(21) Appl. No.: 14/112,314

(22) PCT Filed: Apr. 16, 2012
(86) PCT No.: PCT/KR12/02868

§ 371 Date: Nov. 25, 2013

(30) Foreign Application Priority Data
Apr. 20, 2011 (KR) 10-2011-0036781

(51) Int. Cl. H04R 1/00

(52) U.S. Cl. CPC H04R 1/00
USPC 381/162

(57) ABSTRACT

The present invention relates to a flat-type speaker, and more particularly, to a flat-type speaker in which a plurality of magnetic circuits are consecutively connected in series or in parallel so as to constitute one speaker. In the flat-type speaker in which the plurality of magnetic circuits are consecutively connected, two or more voice coil plates, on each of which voice coils are printed, are successively arranged, and two or more vibrating-reed plates in the form of a thin film are arranged on the upper ends of the two or more voice coil plates, respectively, such that said vibrating-reed plates are electrically isolated from each other. Also, said voice coils and said two or more vibrating-reed plates are electrically connected together.

### TECHNICAL FIELD

The present invention relates to a flat type speaker and, more particularly, to a flat type speaker formed by consecutively coupling a plurality of magnetic circuits in series or in parallel into one speaker.

### BACKGROUND ART

A speaker includes a voice coil plate and a vibration plate interposed between magnets and generates sound when the vibration plate is vibrated by a movement of the voice coil plate.

A voice coil plate used in a flat type speaker is wound in an elliptical form and print-patterned on one side or both sides of a coil base of a plate form.

When current flows through a voice coil, the voice coil plate generates a magnetic field that is expanded and contracted around the voice coil in the same frequency as that of an audio signal by means of the flowing current. Since the magnetic field generated from the magnets within the speaker unit is applied to the voice coil, the voice coil plate moves up and down in response to the magnetic field while interacting with the magnetic field generated from the voice coil. Since the voice coil plate is connected to the vibration plate of the speaker unit, the vibration plate pushes air by way of the up and down movements and thus sound is generated by the vibration of the air.

Such a flat type speaker is being developed to have a gradually slim and long structure in line with an increase of an output capacity. Furthermore, in order to increase the output capacity of the flat type speaker, the development of a flat type speaker having a plurality of magnetic circuits connected emerges as an important problem.

### DISCLOSURE

### Technical Problem

The present invention has been made to solve the above problems, and the present invention proposes a flat type speaker in which a plurality of magnetic circuits is connected.

### Technical Solution

In a flat type speaker in which a plurality of magnetic circuits is consecutively connected in accordance with the present invention for solving the above object, two or more voice coil plates on which respective voice coils are printed are consecutively disposed, two or more vibration-lead plates of a slim and thin film form are electrically separated and placed on top of the two or more voice coil plates, and the voice coils and the two or more vibration-lead plates are electrically connected.

Here, power supply terminals for supplying power preferably are formed at both ends of two vibration-lead plates of the two or more vibration-lead plates.

Here, it is preferred that the two or more vibration-lead plates be formed of a pair of vibration-lead plates and each of the pair of vibration-lead plates include a contact spline electrically connected with the voice coil, a vibration spline brought in surface contact with the vibration plate on top, and a wing spline connecting the contact spline and the vibration spline.

Here, two vibration-lead plates of the two or more vibration-lead plates preferably include contact splines electrically connected with the voice coils, vibration splines brought in surface contact with a vibration plate placed on top, and wing splines connecting the contact splines and the vibration splines, and another vibration-lead plate of the two or more vibration-lead plates preferably includes a contact spline electrically connected with the voice coils.

Here, connection terminals of a thin copper plate form preferably are formed at portions where the two or more vibration-lead plates and the voice coils are electrically connected.

Here, the voice coils preferably are connected in series or in parallel depending on an electrical short and opening between the two or more vibration-lead plates and the voice coils.

Here, if the voice coils form a parallel connection, the two or more vibration-lead plates comprise a pair of vibration-lead plates, it is preferred that the pair of vibration-lead plates be symmetrical to each other, rotated by 180 degrees, and placed, and each of the pair of vibration-lead plates be electrically connected at each voice coil.

Here, if the voice coils form a serial connection, it is preferred that the two or more vibration-lead plates include a pair of vibration-lead plates and each of the pair of vibration-lead plates be electrically connected at each voice coil.

Here, if the voice coils form a serial connection, it is preferred that the pair of vibration-lead plates be symmetrical to each other, rotated by 180 degrees, and placed, when one of the vibration-lead plates is connected with one voice coil, the other vibration-lead plate be connected to the other voice coil, and the other of the vibration-lead plates be formed in a straight-line form for electrically connecting two voice coils.

Here, the bottom of the two or more voice coil plates may be implemented to be mounted in a seating unit placed in the vertical central part of a rectangle damper, and the outer side of the damper may be implemented to be mounted on a damper guide formed in the outer block of a base frame that forms an external appearance.

### Advantageous Effects

In accordance with the above-described construction of the present invention, a difficult problem in the high output of a single structure flat type speaker, a difficult problem in the development of a speaker having a very slim and long structure, and a difficult problem in which a central part is bent by force generated because magnetic circuits configured to have N, S pole structures pull toward each other as a speaker becomes slim and very long can be overcome.

Furthermore, productivity and a reduction of a defective ratio can be significantly improved by obviating wires and lead wires within a flat type speaker unit.

Furthermore, a slim, flat, and high-output flat type speaker can be developed because more sound energy is transferred to the vibration plate by way of the continuous magnetic circuits, the up and down movements of the voice film, and a surface-to-surface contact between the vibration-lead plates and the vibration plate.

### DESCRIPTION OF DRAWINGS

FIG. 1 is an exploded perspective view showing the parallel connection structure of a flat type speaker in which a plurality of magnetic circuits is consecutively connected in accordance with a first embodiment of the present invention.

FIG. 2 is a perspective view illustrating the parallel connection structure of a plurality of magnetic circuits and the structure of vibration-lead plates of FIG. 1.

FIG. 3 is an exploded perspective view showing the serial connection structure of a flat type speaker in which a plurality of magnetic circuits is consecutively connected in accordance with a second embodiment of the present invention.

FIG. 4 is a perspective view illustrating the serial connection structure of a plurality of magnetic circuits and the structure of vibration-lead plates of FIG. 3.

FIG. 5 is an exploded perspective view showing the serial connection structure of a flat type speaker in which a plurality of magnetic circuits is consecutively connected in accordance with a third embodiment of the present invention.

FIG. 6 is a perspective view illustrating the parallel connection structure of a plurality of magnetic circuits and the structure of vibration-lead plates of FIG. 5.

FIG. 7 is a perspective view showing the connection structure of the base frame, the voice coil plates, and the damper of a flat type speaker in which a plurality of magnetic circuits is consecutively connected in accordance with the present invention.

### DESCRIPTION OF REFERENCE NUMERALS OF PRINCIPAL ELEMENTS IN THE DRAWINGS

11, 31, 51, 71: base frame
12a, 12b, 32a, 32b, 52a, 52b: magnetic body
13a, 13b, 33a, 33b, 53a, 53b, 73a, 73b: voice coil plate
14a, 14b, 34a, 34b, 53a, 53b: vibration-lead plate
15, 35, 55: vibration plate
16, 36, 56, 76: damper
71a: damper guide
76a: damper bridge
76b: seating unit

### MODE FOR INVENTION

Hereinafter, the structures of the magnet plate and the base frame of a flat type speaker in accordance with the present invention are described with reference to the accompanying drawings.

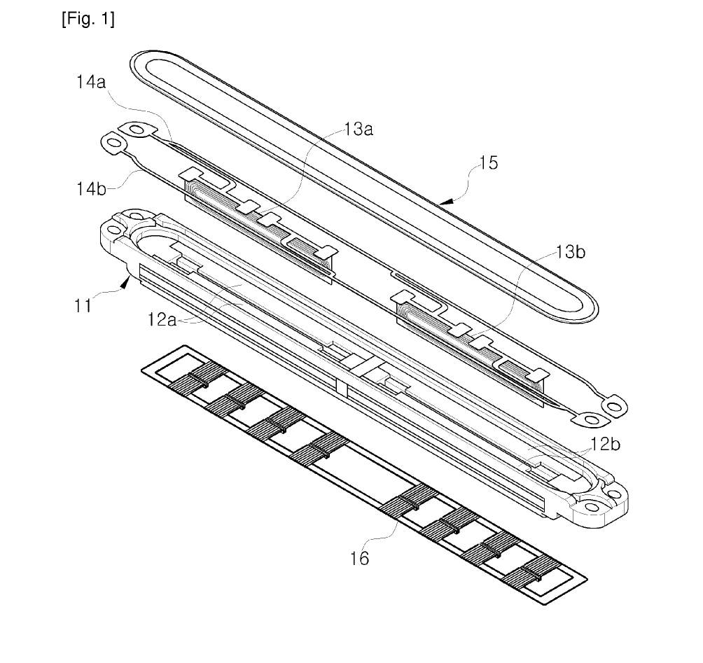

A plurality of magnetic circuits described herein means a case where the number of voice coil plates each having a voice coil printed thereon is two or more. Each of flat type speakers shown in FIGS. 1 to 6 described as preferred embodiments corresponds to a case where two voice coil plates (or magnetic circuits) are consecutively disposed, and the same principle can be applied to a case where three or more voice coil plates (or magnetic circuits) are consecutively disposed.

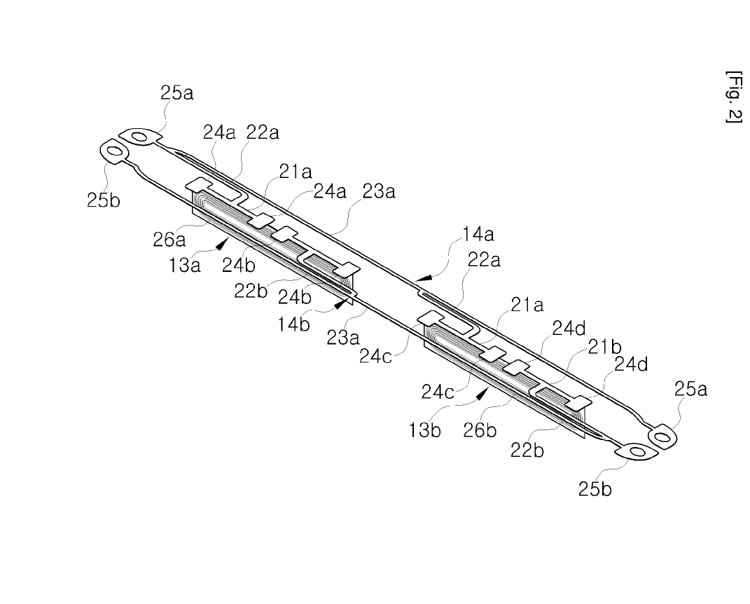

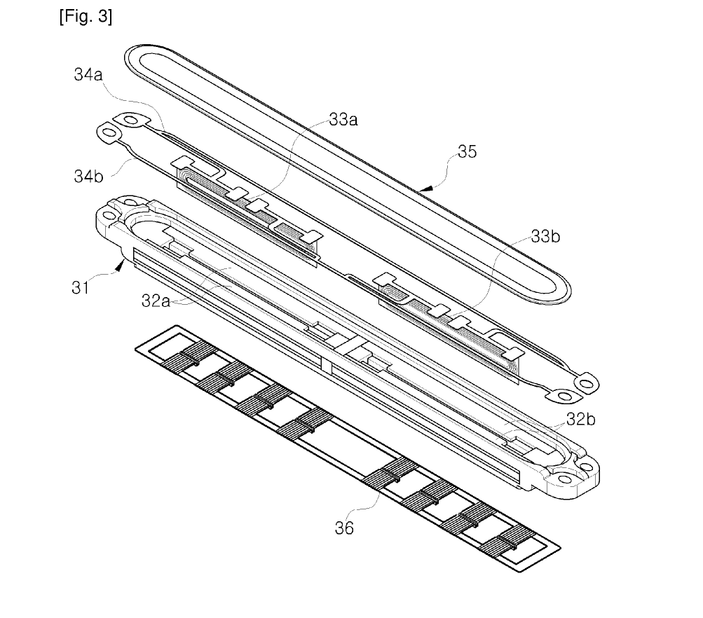

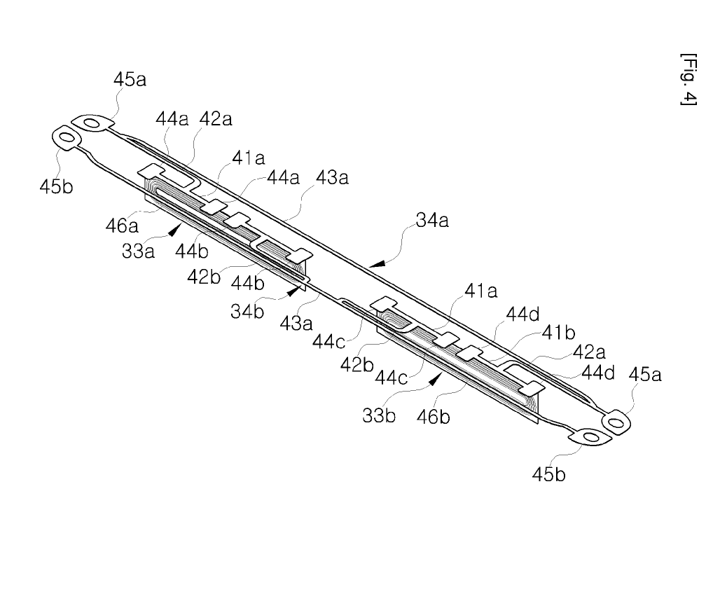

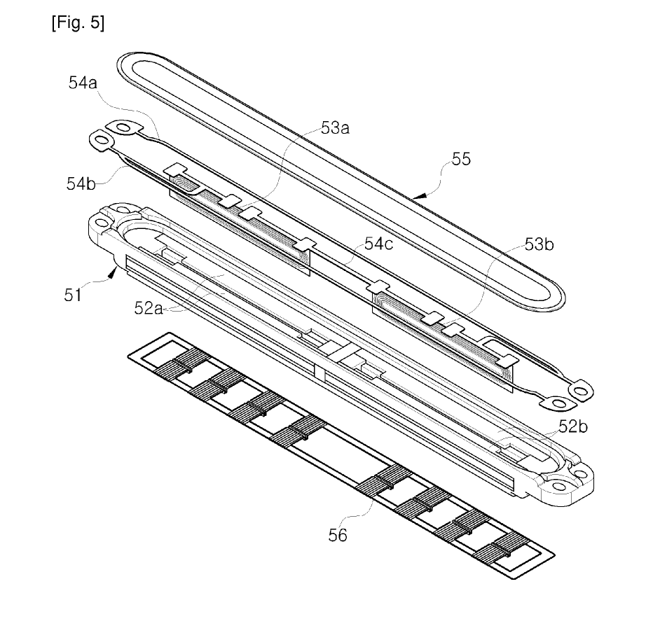

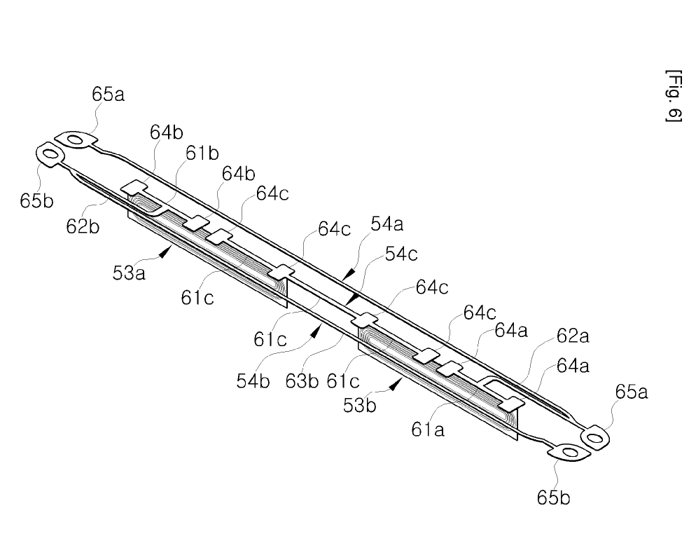

A structure in which two or more voice coils (magnetic circuits) are electrically connected has a structure in which vibration-lead plates are used and a plurality of magnetic circuits is connected in parallel or in series by connecting the vibration-lead plates and the voice coils. The parallel connection structure of a plurality of magnetic circuits is described with reference to FIGS. 1 and 2. An example of the serial connection structure of a plurality of magnetic circuits is described with reference to FIGS. 3 and 4, and another example of the serial connection structure thereof is described with reference to FIGS. 5 and 6.

### First Embodiment of a Flat Type Speaker in which a Plurality of Magnetic Circuits is Consecutively Connected

FIG. 1 is an exploded perspective view showing the parallel connection structure of a flat type speaker in which a plurality of magnetic circuits is consecutively connected in accordance with a first embodiment of the present invention.

As shown in FIG. 1, the flat type speaker in accordance with the first embodiment of the present invention is configured to include a base frame 11, magnetic bodies 12a and 12b, two voice coil plates 13a and 13b, a pair of vibration-lead plates 14a and 14b, a vibration plate 15, and a damper 16.

The base frame 11 forms an external appearance of the flat type speaker. One pair of magnetic bodies 12a having different polarities are horizontally arranged at a constant interval within the base frame 11, and the other pair of magnetic bodies 12b having different polarities are horizontally arranged at a constant interval within the base frame 11.

One pair of magnetic bodies 12a and the other pair of magnetic bodies 12b are horizontally arranged.

The voice coil plates 13a and 13b, each having a voice coil printed-patterned or wound on one side or both sides of the voice coil plate, are placed between one pair of magnetic bodies 12a and the other pair of magnetic bodies 12b, respectively.

The pair of vibration-lead plates 14a and 14b are placed at the tops of the two voice coil plates 13a and 13b. The damper 16 for assisting the vibration of the voice coil plates is placed at the bottoms of the two voice coil plates 13a and 13b.

The pair of vibration-lead plates 14a and 14b are electrically connected to the + and − lead wires of the voice coil plates 13a and 13b. Terminal posts to which external power is supplied are formed at two places at both ends of each of the pair of vibration-lead plates 14a and 14b. The terminal posts are placed at portions formed at both ends of the base frame 11.

The vibration plate 15 is placed over the pair of vibration-lead plates 14a and 14b, and the vibration-lead plates 14a and 14b and the vibration plate 15 are brought in surface-contact with each other. The surface contact transfers more sound energy to the vibration plate 15.

In such a structure, when external power is applied through the power supply terminal of the vibration-lead plates 14a and 14b, current flows through the voice coils formed on the voice coil plates 13a and 13b. The flowing current generates a magnetic field that is expanded and contracted in the same frequency as that of an audio signal around the voice coils.

The magnetic field generated from the magnetic bodies 12a and 12b within the flat type speaker is applied to the voice coils. The voice coil plates 13a and 13b are vibrated up and down in response to the magnetic field while interacting with the magnetic field generated from the voice coils. Since the voice coil plates 13a and 13b are connected to the vibration plate 15 of the flat type speaker by means of the vibration-lead plates 14a and 14b, the vibration plate 15 is vibrated up and down, thus pushing air. As a result, sound is generated by the vibration of the air.

A flat type speaker needs to be improved to have a structure capable of 2 W to high-capacity output in the future. The length of a flat type speaker having high-capacity output is inevitably increased, and the width of the flat type speaker is also inevitably narrowed.

Accordingly, the present invention discloses a speaker structure that complies with the high-output speaker of the slim and long flat type speaker.

In order to propose a high-output speaker, the present invention proposes a structure in which two or more magnetic circuits are consecutively connected, wherein in order to electrically couple the magnetic circuits, vibration-lead plates are formed and electrically connected with voice coil plates, and the vibration-lead plates are brought in surface contact with the vibration plate at the top, thereby maximizing the transfer of sound energy to the vibration plate.

FIG. 2 is a perspective view illustrating the parallel connection structure of a plurality of magnetic circuits and the structure of vibration-lead plates of FIG. 1.

As shown in FIG. 2, vibration-lead plates 14a and 14b are formed in pairs, and two voice coil plates 13a and 13b are consecutively horizontally arranged.

The voice coil plates 13a and 13b may be consecutively added horizontally in order to further increase the output capacity of the speaker. Here, only the length of the vibration-lead plates 14a and 14b and the structure of splines thereof are changed, but a pair of the vibration-lead plates 14a and 14b are always formed.

Various types of splines that form the vibration-lead plates 14a and 14b in this specification are dictionary meanings, and they mean slim, long, and thin plates, such as metal.

The voice coil plates 13a and 13b include voice coils 26a and 26b patterned and printed in a track form. Each of the voice coils 26a and 26b is printed on both sides of each of the voice coil plates 13a and 13b.

The voice coils 26a and 26b have + and − lead wires electrically connected with the vibration-lead plates 14a and 14b.

The vibration-lead plates 14a and 14b include contact splines 21a and 21b including one or more connection terminals 24a and 24b electrically connected with the voice coils 26a and 26b, respective vibration splines 23a and 23b brought in surface contact with the vibration plate 15 placed at the top, and respective wing splines 22a and 22b connecting the contact splines 21a and 21b and the vibration splines 23a and 23b. Power supply terminals 25a and 25b connected with external power are formed at four places at the respective ends of the vibration-lead plates 14a and 14b.

The pair of vibration-lead plates 14a and 14b are symmetrical to each other on the basis of one of the vibration-lead plates 14a and 14b and are mounted on respective places rotated by 180 degrees. The two vibration-lead plates 14a and 14b preferably are configured to have the same structure in order to improve productivity efficiency.

One lead wire of the voice coil 26a is connected with one terminal (+terminal) of the connection terminal 24a of the vibration-lead plate 14a, and the other lead wire of the voice coil 26a is connected with one terminal (−terminal) of the connection terminal 24b of the vibration-lead plate 14b.

Likewise, one lead wire of the voice coil 26b is connected with one terminal (+terminal) of the connection terminal 24c of the vibration-lead plate 14a, and the other lead wire of the voice coil 26b is connected with one terminal (−terminal) of the connection terminal 24d of the vibration-lead plate 14b.

The two voice coils (magnetic circuits) connected as described above have an electrically parallel connection structure.

The connection terminals 24a to 24d are connected with the power supply terminals 25a and 25b through the wing splines 22a and 22b.

The wing splines 22a and 22b function as mediators for an electrical connect between the power supply terminals 25a and 25b and the connection terminals 24a to 24d. Furthermore, the wing splines 22a and 22b are connected with the contact splines 21a and 21b and the vibration splines 23a and 23b, thus functioning as damper bridges for increasing the vibration energy of the vibration splines 23a and 23b.

The vibration splines 23a and 23b are brought in surface contact with the vibration plate 15 at the top, so that vibration energy can be efficiently transferred to the vibration plate 15.

In conclusion, the vibration-lead plates 14a and 14b are mounted under the vibration plate 15 in a surface manner, and they function to maximize sound energy output by vibrating more vibration energy along with the vibration plate 15. Furthermore, the + and −terminals are formed at both ends of each of the vibration-lead plates 14a and 14b, and the vibration-lead plates 14a and 14b are formed of metal plates. Accordingly, a failure attributable to the disconnection of a lead wire is eliminated and difficulties in process are solved by obviating the soldering connection of the existing lead wires (silver lines) used to connect the voice coils and a circuit and replacing the role of the lead wire with the metal plate.

### Second Embodiment of a Flat Type Speaker in which a Plurality of Magnetic Circuits is Consecutively Connected

FIG. 3 is an exploded perspective view showing the serial connection structure of a flat type speaker in which a plurality of magnetic circuits is consecutively connected in accordance with a second embodiment of the present invention, and FIG. 4 is a perspective view illustrating the serial connection structure of the plurality of magnetic circuits and the structure of vibration-lead plates of FIG. 3.

As shown in FIG. 3, the flat type speaker in accordance with the second embodiment of the present invention is configured to include a base frame 31, magnetic bodies 32a and 32b, two voice coil plates 33a and 33b, a pair of vibration-lead plates 34a and 34b, a vibration plate 35, and a damper 36.

The second embodiment of the present invention shown in FIG. 3 has the same construction as the first embodiment except the structure of vibration-lead plates and a connection structure between the vibration-lead plate and a voice coil. Thus, only the structure of the vibration-lead plates and a connection structure between the vibration-lead plate and the voice coil are described below.

As shown in FIG. 4, vibration-lead plates 34a and 34b are formed in pairs, and two voice coil plates 33a and 33b are consecutively arranged horizontally.

The voice coil plates 33a and 33b include voice coils 46a and 46b patterned and printed in a track form, and each of the voice coils 46a and 46b is printed on both sides of each of the voice coil plates 33a and 33b.

The + and − lead wires of the voice coils 46a and 46b are electrically connected with the vibration-lead plates 34a and 34b.

The vibration-lead plates 34a and 34b include respective contact splines 41a and 41b including one or more connection terminals 44a and 44b electrically connected with the voice coils 46a and 46b, respective vibration splines 43a and 43b brought in surface contact with the vibration plate 15 placed at the top, and wing splines 42a and 42b connecting the contact splines 41a and 41b and the vibration splines 43a and 43b. Power supply terminals 45a and 45b connected with external power are formed at four places at the respective ends of the vibration-lead plates 34a and 34b.

In the pair of vibration-lead plates 34a and 34b, the contact spline 41a is placed inside and the contact spline 41b is placed outside on the basis of the voice coil plates 33a and 33b for a serial connection between the voice coils 46a and 46b.

One lead wire of the voice coil 46a of the vibration-lead plate 34a is connected with one terminal (+terminal) of the connection terminal 44a, and the other lead wire of the voice coil 46a is connected with one lead wire of the voice coil 46b.

Likewise, one lead wire of the voice coil 46b is connected with the other lead wire of the voice coil 46a, and the other lead wire of the voice coil 46b is connected with one terminal (−terminal) of the connection terminal 44d of the vibration-lead plates 34b.

The two voice coils (magnetic circuits) connected as described above have the (+) power supply terminal—the first coil—the second coil—the (−) terminal electrically connected in series.

The wing splines 42a and 42b function as mediators for an electrical connection between the power supply terminals 45a and 45b and the connection terminals 44a to 44d. Furthermore, the wing splines 42a and 42b are connected with the contact splines 41a and 41b and the vibration splines 43a and 43b, thus functioning as damper bridges for increasing the vibration energy of the vibration splines 43a and 43b.

The vibration splines 43a and 43b are brought in surface contact with the vibration plate 35 at the top, so that vibration energy can be efficiently transferred to the vibration plate 35.

### Third Embodiment of a Flat Type Speaker in which a Plurality of Magnetic Circuits is Consecutively Connected

FIG. 5 is an exploded perspective view showing the serial connection structure of a flat type speaker in which a plurality of magnetic circuits is consecutively connected in accordance with a third embodiment of the present invention, and FIG. 6 is a perspective view illustrating the parallel connection structure of the plurality of magnetic circuits and the structure of vibration-lead plates of FIG. 5.

As shown in FIG. 5, the flat type speaker in accordance with the third embodiment of the present invention is configured to include a base frame 51, magnetic bodies 52a and 52b, two voice coil plates 53a and 53b, three vibration-lead plates 54a, 54b, 54c, a vibration plate 55, and a damper 56.

The third embodiment of the present invention shown in FIG. 5 has the same construction as the first embodiment except the structure of vibration-lead plates and a connection structure between the vibration-lead plate and a voice coil. Thus, only the structure of the vibration-lead plates and the connection structure between the vibration-lead plate and the voice coil are described below.

As shown in FIG. 5, the three vibration-lead plates 54a, 54b, and 54c are formed, and the two voice coil plates 53a and 53b are consecutively arranged horizontally.

The voice coil plates 53a and 53b include voice coils 66a and 66b patterned and printed in a track form, and each of the voice coils 66a and 66b is printed on both sides of each of the voice coil plates 53a and 53b.

The + and − lead wires of the voice coils 66a and 66b are electrically connected with the vibration-lead plates 54a and 54b.

The vibration-lead plate 54 includes the pair of vibration-lead plates 54a, 54b and second contact splines 61c having one or more connection terminals 64c and 64d electrically connected with the voice coils 66a and 66b.

The pair of vibration-lead plates 54a and 54b include respective first contact splines 61a and 61b including the one or more connection terminals 64a and 64b electrically connected with the voice coils 66a and 66b, respective vibration splines 63a and 63b brought in surface contact with the vibration plate 55 placed at the top, and respective wing splines 62a and 62b connecting the contact splines 61a and 61b and the vibration splines 63a and 63b. Power supply terminals 65a and 65b connected with external power are formed at four places at the respective ends of the vibration-lead plates 54a and 54b.

The pair of vibration-lead plates 54a and 54b are symmetrical to each other on the basis of one of the vibration-lead plates 54a and 54b and are mounted on respective places rotated by 180 degrees. The two vibration-lead plates 54a and 54b are configured to have the same structure in order to improve productivity efficiency.

Furthermore, in order to connect the two voice coils 66a and 66b in series in a straight-line form, the second contact splines 61c are placed inside, and the first contact splines 61a and 61b are placed outside on the basis of the voice coil plates 53a and 53b.

One lead wire of the voice coil 66a is connected with one terminal (+terminal) of the connection terminal 64b of the vibration-lead plate 54b, and the other lead wire of the voice coil 66a is connected with one terminal of the connection terminal 64c of the second contact spline 61c.

Likewise, one lead wire of the voice coil 66b is connected with one terminal of the connection terminal 64d of the second contact spline 61c, and the other lead wire of the voice coil 66b is connected with one terminal (−terminal) of the connection terminal 64a of the vibration-lead plates 54a.

The two voice coils (magnetic circuits) connected as described have the (+) power supply terminal—the first coil—the second contact spline—the second coil—the (−) terminal electrically connected in series.

The wing splines 62a and 62b function as mediators for electrically connecting the power supply terminals 65a and 65b and the connection terminals 64a to 64d. Furthermore, the wing splines 62a and 62b are connected with the contact splines 61a and 61b and the vibration splines 63a and 63b, thus functioning as damper bridges for increasing the vibration energy of the vibration splines 63a and 63b.

The vibration splines 6a and 6b are brought in surface contact with the vibration plate 55 at the top so that vibration energy can be efficiently transferred to the vibration plate 55.

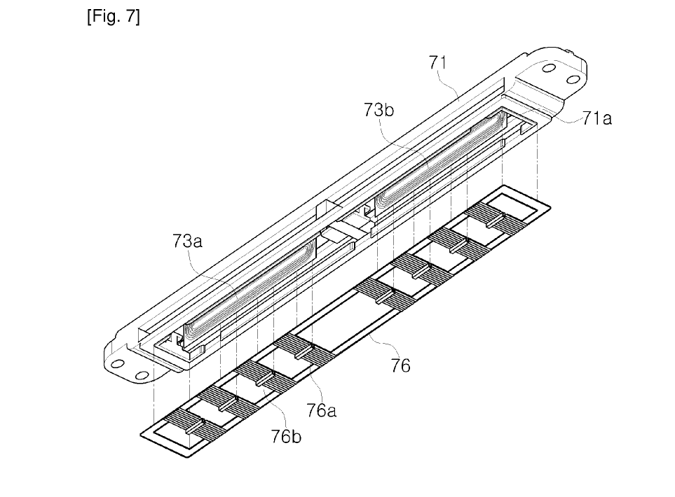

FIG. 7 is a perspective view showing the connection structure of the base frame, the voice coil plates, and the damper of a flat type speaker in which a plurality of magnetic circuits is consecutively connected in accordance with the present invention.

If two or more voice coil plates are consecutively connected, it becomes a very important factor to maintain the center of the voice coil plate in order to prevent unbalanced vibration due to the increased length of the speaker. A damper 76 is used to precisely maintain the center of the voice coil plate or assist the vibration of the voice coil plate.

The damper 76 is formed in a rectangle form. A plurality of damper bridges 76a is formed in the damper 76, and a seating unit 76b into which voice coil plates 73a and 73b are inserted and seated are formed at the center of the damper bridge. The four sides of the damper 76 are precisely placed at a portion of a damper guide 71a formed in an outer block at the bottom of a base frame 71.

The connection structure of the base frame, the voice coil plated, and the damper of FIG. 7 can be equally applied to the embodiments shown in FIGS. 1 to 6.

While preferred embodiments of the present invention have been described with reference to the accompanying drawings, those skilled in the art to which the present invention pertains will understand that the present invention may be implemented in other detailed forms without departing from the technical spirit or essential characteristics of the present invention. Therefore, the aforementioned embodiments should not be construed as being limitative, but should be construed as being only illustrative from all aspects. Furthermore, the scope of the present invention is defined by the appended claims rather than the detailed description. It should be understood that all modifications or variations derived from the meanings and scope of the present invention and equivalents thereof are included in the scope of the present invention.

1. A flat type speaker in which a plurality of magnetic circuits is consecutively connected,
wherein two or more voice coil plates on which respective voice coils are printed are consecutively disposed,
two or more vibration-lead plates of a slim and thin film form are electrically separated and placed on top of the two or more voice coil plates, and
the voice coils and the two or more vibration-lead plates are electrically connected.

2. The flat type speaker of claim 1, wherein power supply terminals for supplying power are formed at both ends of two vibration-lead plates of the two or more vibration-lead plates.

3. The flat type speaker of claim 1, wherein:
the two or more vibration-lead plates are formed of a pair of vibration-lead plates, and
each of the pair of vibration-lead plates comprises a contact spline electrically connected with the voice coil, a vibration spline brought in surface contact with the vibration plate on top, and a wing spline connecting the contact spline and the vibration spline.

4. The flat type speaker of claim 1, wherein:
two vibration-lead plates of the two or more vibration-lead plates comprise contact splines electrically connected with the voice coils, vibration splines brought in surface contact with a vibration plate placed on top, and wing splines connecting the contact splines and the vibration splines, and
another vibration-lead plate of the two or more vibration-lead plates comprises a contact spline electrically connected with the voice coils.

5. The flat type speaker of claim 1, wherein connection terminals of a thin copper plate form are formed at portions where the two or more vibration-lead plates and the voice coils are electrically connected.

6. The flat type speaker of claim 1, wherein the voice coils are connected in series or in parallel depending on an electrical short and opening between the two or more vibration-lead plates and the voice coils.

7. The flat type speaker of claim 6, wherein:
if the voice coils form a parallel connection, the two or more vibration-lead plates comprise a pair of vibration-lead plates,
the pair of vibration-lead plates are symmetrical to each other, rotated by 180 degrees, and placed, and
each of the pair of vibration-lead plates is electrically connected at each voice coil.

8. The flat type speaker of claim 6, wherein:
if the voice coils form a serial connection, the two or more vibration-lead plates comprise a pair of vibration-lead plates, and
each of the pair of vibration-lead plates is electrically connected at each voice coil.

9. The flat type speaker of claim 6, wherein:
if the voice coils form a serial connection, the pair of vibration-lead plates are symmetrical to each other, rotated by 180 degrees, and placed,
when one of the vibration-lead plates is connected with one voice coil, the other vibration-lead plate is connected to the other voice coil, and
the other of the vibration-lead plates is formed in a straight-line form for electrically connecting two voice coils.

10. The flat type speaker of claim 1, wherein:
a bottom of the two or more voice coil plates is mounted in a seating unit placed in a vertical central part of a rectangle damper, and
an outer side of the damper is mounted on a damper guide formed in an outer block of a base frame that forms an external appearance.
